(19) United States
(12) Patent Application Publication
(10) Pub. No.: US 2014/0283422 A1
(43) Pub. Date: Sep. 25, 2014

(54) Attachment bracket for use with heavy machinery and bracket members

(71) Applicant: Alain Cloutier, Riviere-Heva (CA)

(72) Inventor: Alain Cloutier, Riviere-Heva (CA)

(21) Appl. No.: 13/847,115

(22) Filed: Mar. 19, 2013

(51) Int. Cl. B60D 1/04; E02F 9/00

(52) U.S. Cl. CPC B60D 1/04; E02F 9/00
USPC 37/403; 280/504

(57) ABSTRACT

An attachment bracket for use with heavy machinery and adapted to releasably attach to a double wheeled bin. The attachment bracket has a plurality of spaced parallel elongated bracket frame members, an elongated wide plate member connected to each the bracket frame member forming a rigid connection therebetween, a pair of spaced main hook members removably and adjustably connected to the wide plate member in between the bracket frame members, and a pair of secondary hook members, each rotationally connected to a respective the main hook member and biased such that they will return to an initial position when not being forced to rotate.

This application claims priority based on request GB1204803.9 filed Mar. 19, 2012

### FIELD OF THE INVENTION

The present invention relates generally to construction equipment but more particularly to an attachment bracket for use with heavy machinery and bracket members.

### BACKGROUND OF THE INVENTION

Quite often on a construction site a bin is used for loading and carrying material from place to place around the site. Sometimes the bin used for temporarily storing aggregate material such as dirt or gravel for later use. The problem with those bins is that they are not easy to move around. Sometimes they are dragged on the ground, which is not the best way to move things around. There has to be a better and more efficient way of doing this.

### SUMMARY OF THE INVENTION

In view of the foregoing disadvantages inherent in the known devices now present in the prior art, the present invention, which will be described subsequently in greater detail, is to provide objects and advantages which are:

To provide for an attachment that works with a variety of bins and other such container types that are used for storage and which is easily detachable from a tractor so that it can be set aside for a wile and then be readily reattached for being transported.

In order to do so, the invention consists in an attachment bracket for use with heavy machinery and adapted to releasably attach to a double wheeled bin. The attachment bracket has a plurality of spaced parallel elongated bracket frame members, an elongated wide plate member connected to each the bracket frame member forming a rigid connection therebetween, a pair of spaced main hook members removably and adjustably connected to the wide plate member in between the bracket frame members, and a pair of secondary hook members, each rotationally connected to a respective the main hook member and biased such that they will return to an initial position when not being forced to rotate.

A pair of arms extending in a perpendicular direction from base portions of two of the bracket frame members, and in a direction opposite from the direction the main and secondary hooks extend, each arm having an attachment notch on a distal end thereof. A pair of spaced parallel elongated movable members. At least one connector member extending between and connecting the movable members, and having a length that is greater than the elongated length of the wide plate member, an attachment connector member attached between top portions of the movable member, has a length that is greater than the length of the at least one connector member and is adapted to removably and securely attach to the double wheeled bin.

Two attachment pins respectively located on distal end portions of the movable members and are adapted to respectively rotationally and removably engage with the pair of arms, and two limiting rods respectively located on middle sections of the movable members and are adapted to respectively engage middle portions of the pair of arms thereby limiting rotational movement of the movable members with respect to the pair of arms, such that when the main and secondary hook members are engaged and lifted by heavy machinery the attachment bracket is secured thereon and capable of lifting the double wheeled bin into the air and transporting it to another location.

The attachment bracket is further comprised of a pair of skid members respectively and rotational attached on the distal end portions of the movable members.

The attachment bracket has the secondary hook members biased with respect to the main hook members by coil spring members.

The attachment bracket is further comprised of a pair of piston members connected between respective pairs of the main and secondary hook members, and are adapted to function as shock absorbers in conjunction with the coil spring members.

The attachment bracket is further comprised of a plow plate member securely attached to the bracket frame members on portions thereof adjacent and below the main and secondary hook members; and wherein the plow plate member includes plow hooks adapted to connect with a plow member attach to the heavy machinery.

The attachment bracket has the main and secondary hook members slidably movable and adjustably secured to the wide plate member to thereby be adapted to accommodate and attach to variously sized mechanical members of the heavy machinery.

The attachment bracket is further comprised of ratchet members respectively connected between each main and secondary hook member, to thereby hold the secondary hook members in respective desired position during operation.

The attachment bracket works in combination with a bin and a piece of heavy machinery.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of the invention.

FIGS. 2-5a-b Isometric views showing the operating steps.

FIGS. 6a-b rear and side view, respectively, of the invention.

FIGS. 7a-c Isometric views of the invention with a bin showing the details of the notches and blockers.

FIG. 8 Isometric view showing the frame with hoisting cables.

FIGS. 9a-f Various views of the movable members, arms, and skids.

FIGS. 10a-f Side views of variants of the main, secondary and plow hooks.

FIGS. 11a-c Isometric vies shoeing details of the arm connection and the small hooks connection.

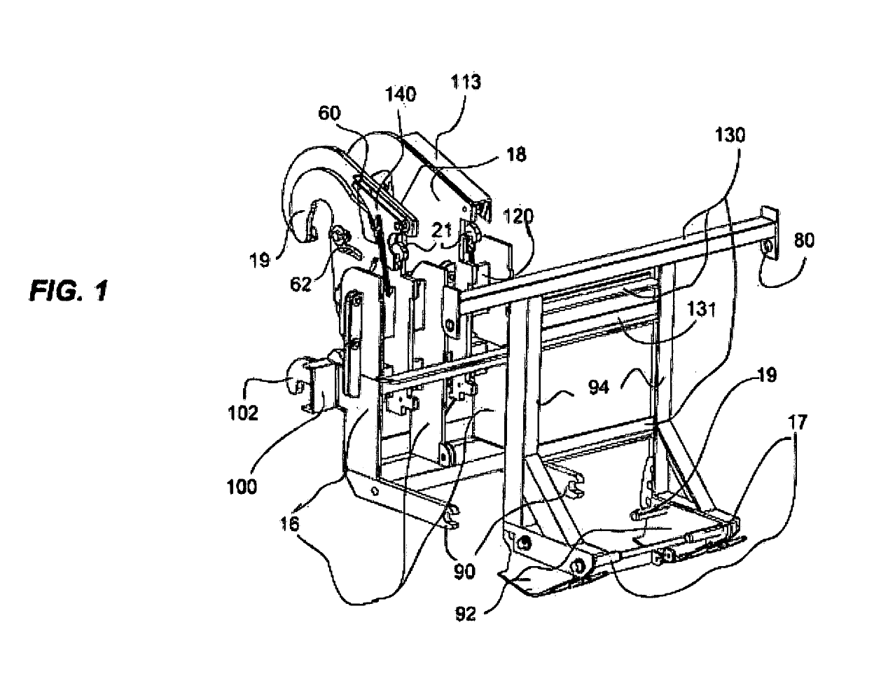

### DETAILED DESCRIPTION OF THE PREFERRED EMBODIMENT

An attachment bracket (10) for use on heavy machinery such as excavators (48), for example, and to which is releasably attached a double wheeled bin (38) having a pair of wheels (34), and a frame (42).

The attachment bracket (10) consists in bracket frame members (16), a pair of main hooks (18) with each main hook (18) rotationally attached to a secondary hook (19). The secondary hooks (19) are biased into a rest configuration by way of biasing means (60).

The attachment bracket (10) has a pair of arms (90) located at the base of the frame members (16) which are rotationally attached to attachment pins (17) which extend from skids (92). Limiting rods (19) limit the rotation of movable members (94) by resting on top of the arms (90). The movable members (94) form part of the frame (42) and are rotatable in relation to the skids (92) but fixed in relation to the bin (38).

Pistons (96) are used as are used shock absorbers with coil springs in suspension systems and are preferable but not essential.

A plow plate (100) has plow hooks (102) to connect with a plow (106) from the excavator (48).

The plow (106) is used for moving the bin (38) around a construction site as well as aligning the wheels (34).

The main hooks (18), as well as the secondary hooks (19) can be adjusted width wise by sliding them along a wide plate (120) so that a variety of bucket (50) sizes can be used.

The movable members (94) are held parallel to each other by way of connector members (130).

A cover plate (113) protects a ratcheting means (140) as well as parts of the hooks (18, 19).

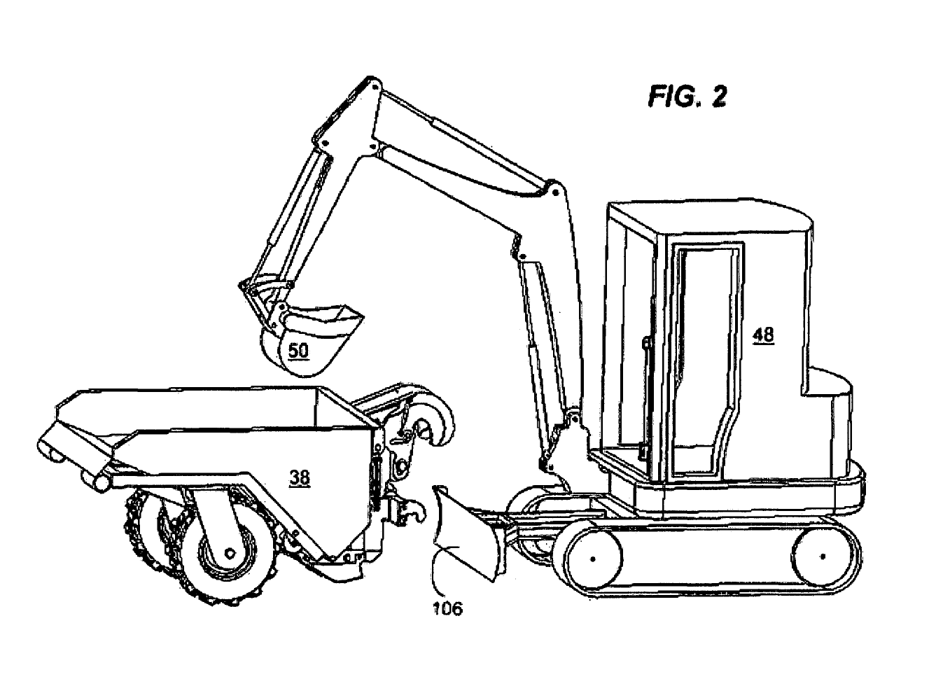

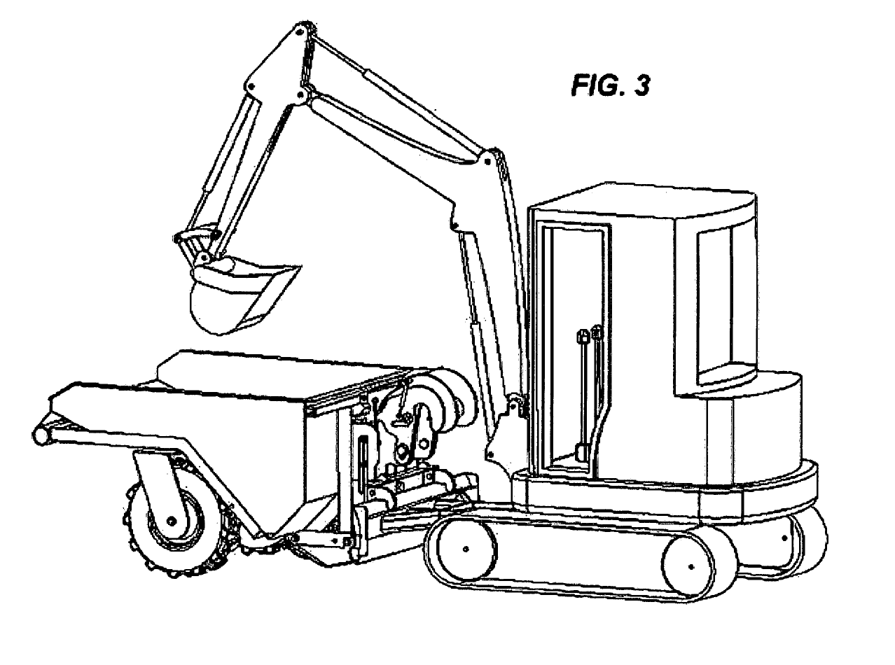

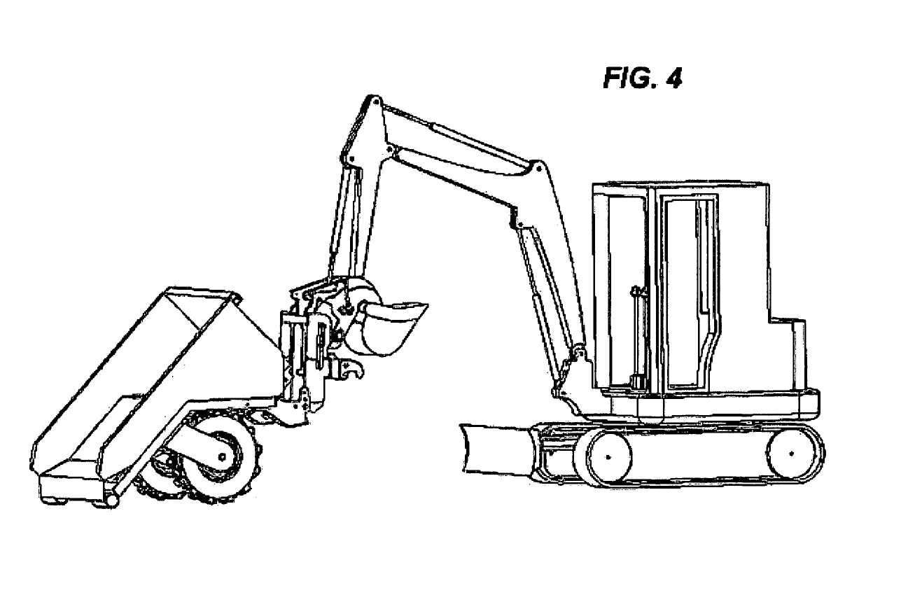

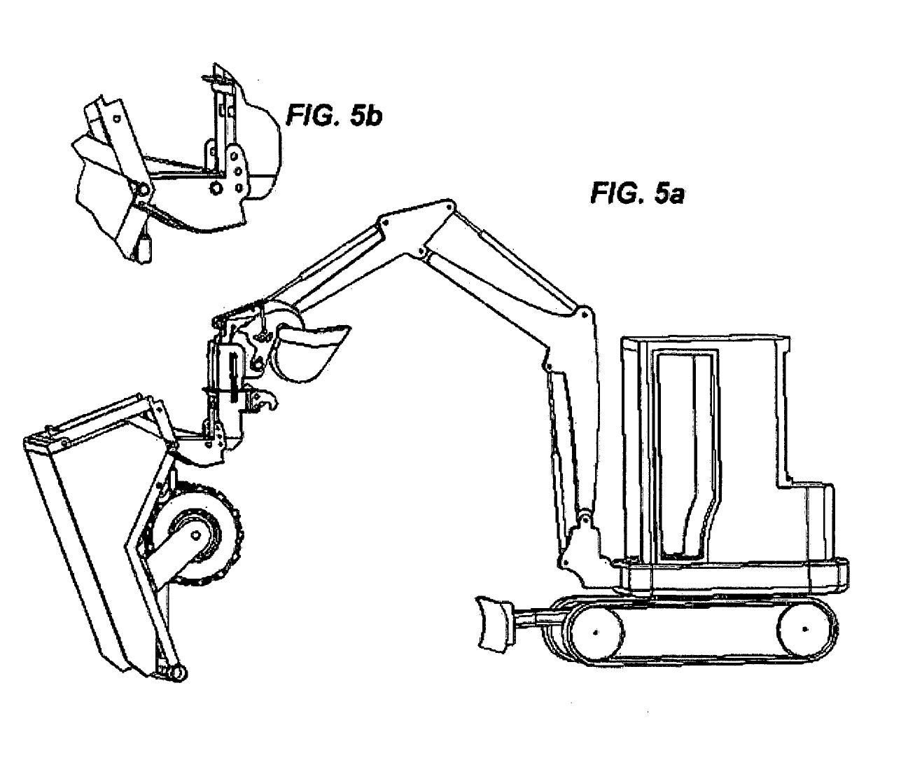

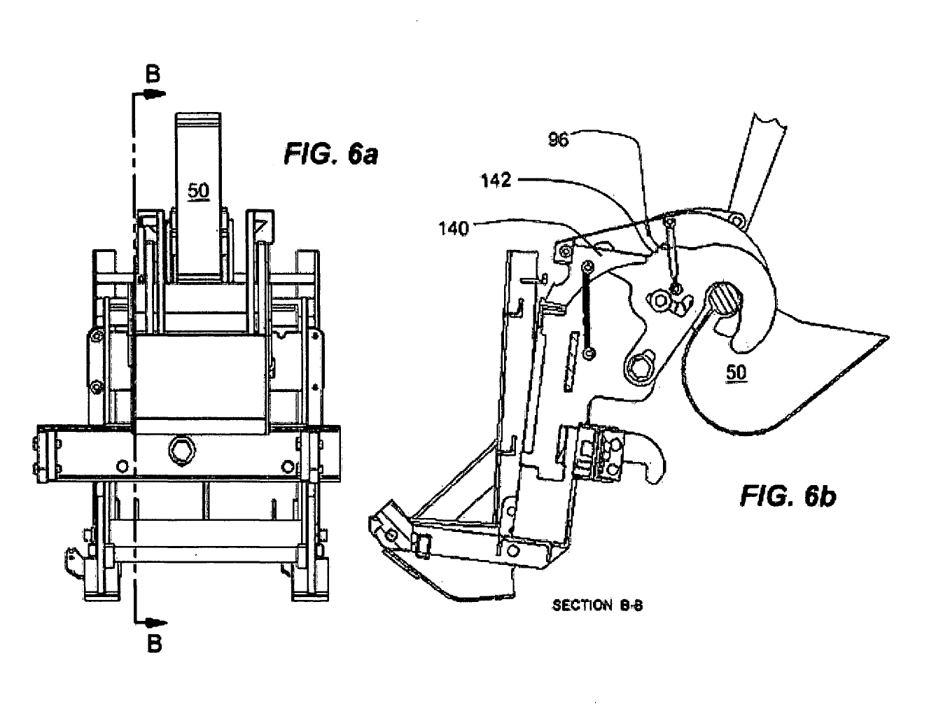

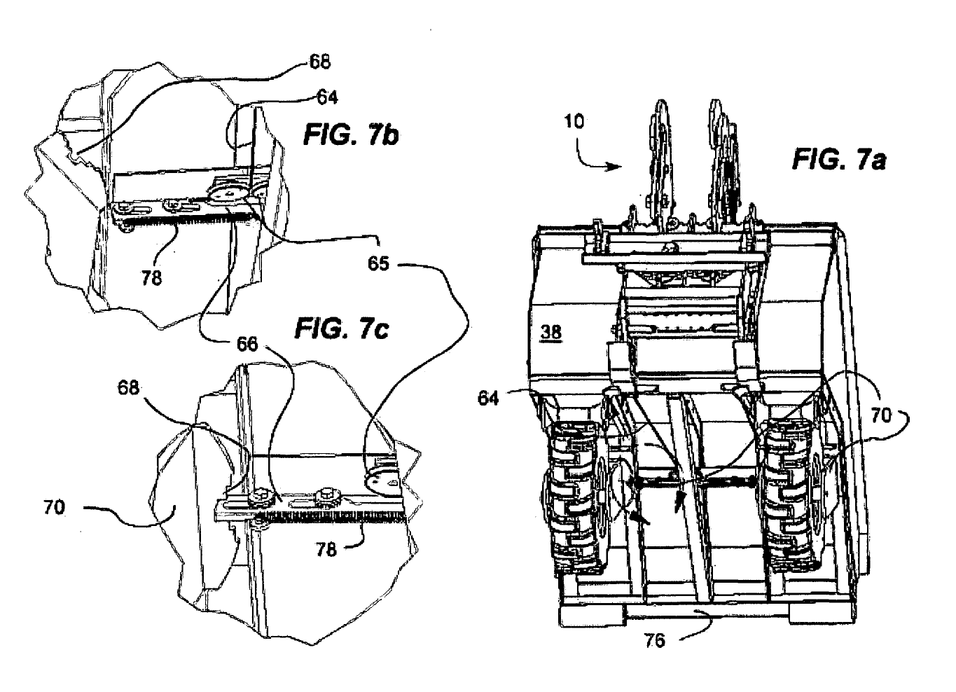

As best seen in FIGS. 2-5, the way the system works is that a bucket (50) from the excavator (48) hooks onto the main hooks (18) while at the same time engaging and moving the secondary hooks (19) backwards, as the bin (38) is lifted, so as to raise small hooks (21) which form part of the secondary hooks. These small hooks (21) hook onto a horizontal bar (131). The movement of the secondary hooks (19) is limited by a channel (62) and as the frame (42) moves in relation to the main hooks (18) at least one cable (64) is pulled, which moves a pair of blockers (66) into wheel locking notches (68). A set of pulleys (65) channels the cable (64) so that it can pull the two blockers (66) simultaneously.

The wheels (34) are connected to rotatable wheel forks (70) and need to be properly aligned and parallel in order to be blocked by the notches (68). The positioning of the wheels (34) is done by the excavator moving the bin (38), and the locking is done by pulling the bin (38) up as stated hereinabove. The alignment of the wheels (34) is critical in order to lift the bin (38) straight up. Because there are several locking notches (68), this gives some leeway so that the wheels (34) do not have to be perfectly aligned and parallel, which is often the case in actual practice.

Lifting the bin (38) makes the weight push against the wheels (34) and the forks (70), which could cause undue stress. So, a pair of support wheels (74) take the load until the weight is transferred onto a rim (76) at the front of the bin (38).

Reversing the operation unlocks the wheels (34) by having blocker biasing means (78) pull the blockers (66) out of the notches (68). Also, the small hooks (21) which are kept in a raised position by a ratcheting means (140) engaging a set of teeth (142), are released as contact from the horizontal bar (131) moves the ratcheting means (140) out of the teeth (142) so that the secondary hooks (19) can rotate and bring the small hooks (21) back down to hook the horizontal bar (131).

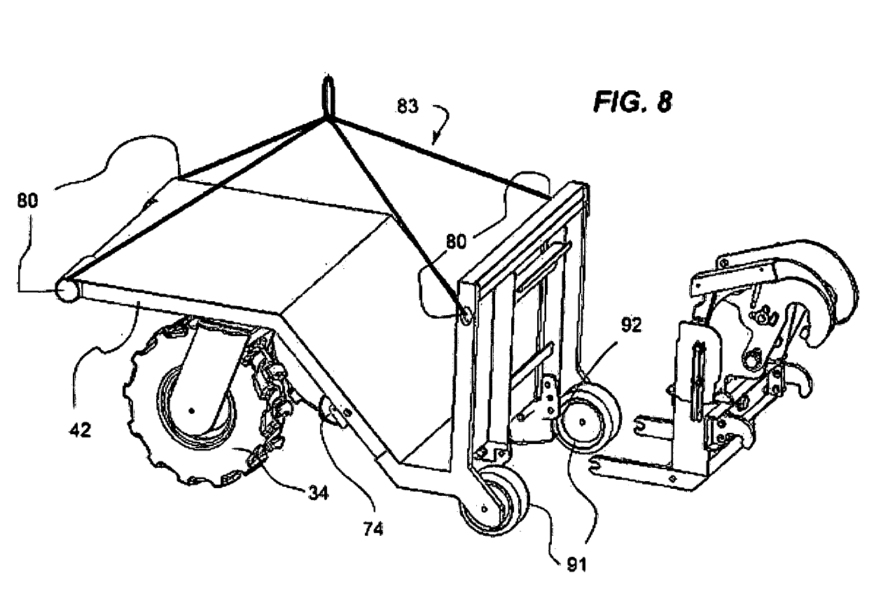

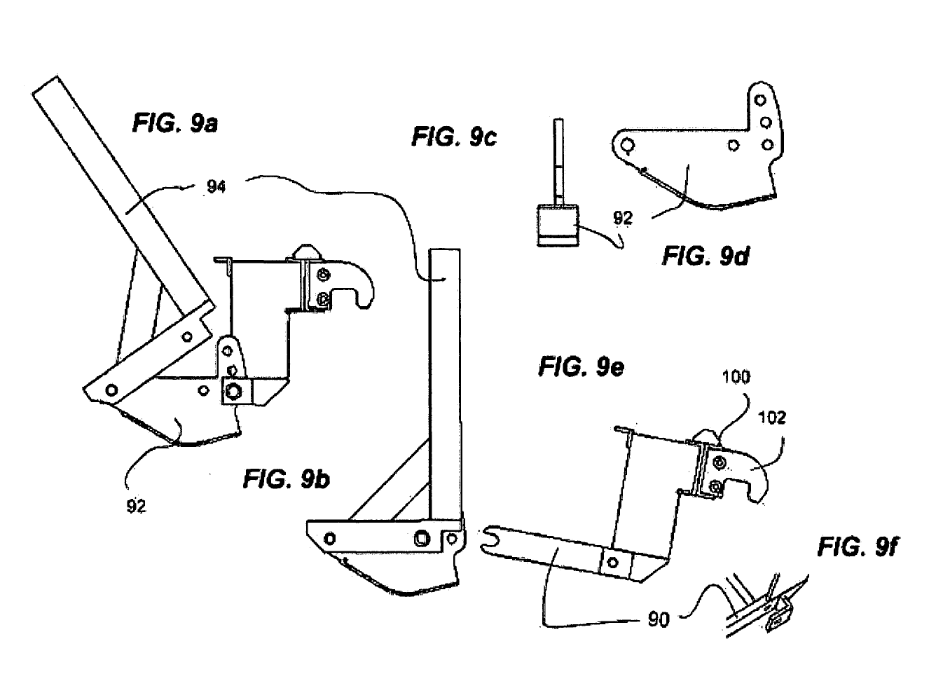

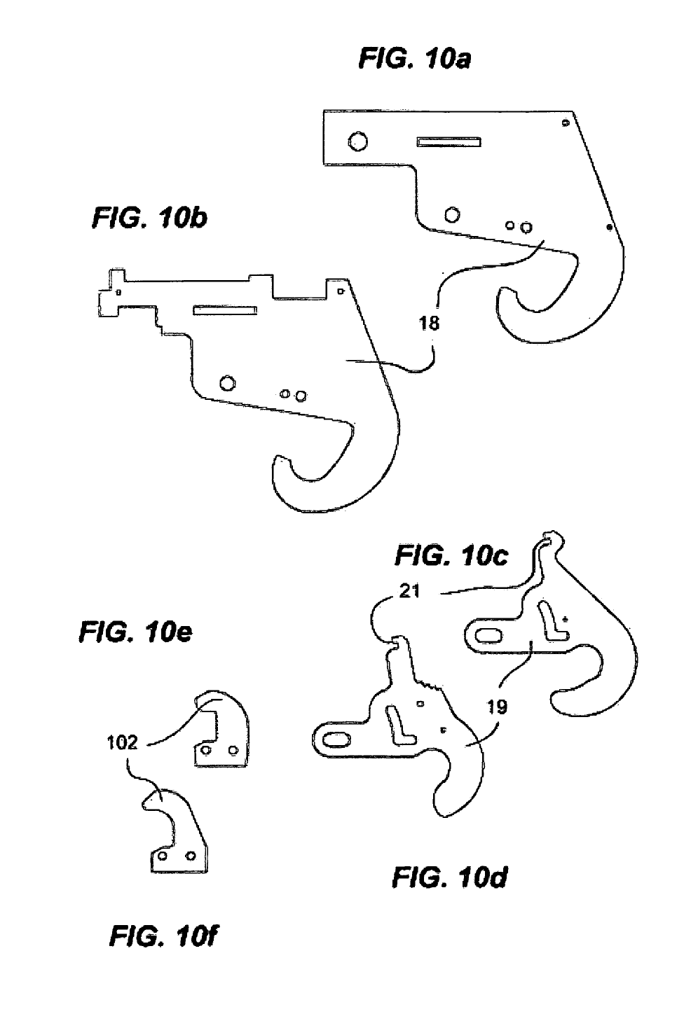

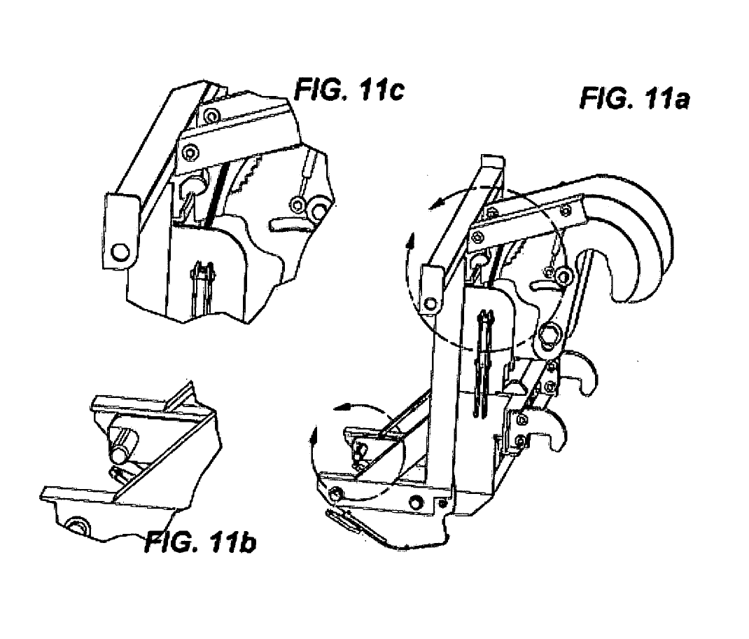

The bin (38) can consist of only its frame (42) onto which can be releasably attached a custom made container bin. Also, special hooking points (80) can be made into the frame (42) so that it can be lifted by way of hoisting cables (83) as seen in FIG. 8 for example.

Some variants include a (38) having casters (91), as seen in FIG. 8. A variant has the casters (91) being pivotable (not shown).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An attachment bracket for use with heavy machinery and adapted to releasably attach to a double wheeled bin, said attachment bracket comprising of a plurality of spaced parallel elongated bracket frame members; an elongated wide plate member connected to each said bracket frame member forming a rigid connection therebetween; a pair of spaced main hook members removably and adjustably connected to said wide plate member in between said bracket frame members; a pair of secondary hook members, each rotationally connected to a respective said main hook member and biased such that they will return to an initial position when not being forced to rotate; a pair of arms extending in a perpendicular direction from base portions of two of said bracket frame members, and in a direction opposite from the direction said main and secondary hooks extend, each arm having an attachment notch on a distal end thereof; a pair of spaced parallel elongated movable members; at least one connector member extending between and connecting said movable members, and having a length that is greater than the elongated length of said wide plate member; an attachment connector member attached between top portions of said movable member, has a length that is greater than the length of said at least one connector member and is adapted to removably and securely attach to said double wheeled bin; two attachment pins respectively located on distal end portions of said movable members and are adapted to respectively rotationally and removably engage with said pair of arms; and two limiting rods respectively located on middle sections of said movable members and are adapted to respectively engage middle portions of said pair of arms thereby limiting rotational movement of said movable members with respect to said pair of arms, such that when said main and secondary hook members are engaged and lifted by heavy machinery said attachment bracket is secured thereon and capable of lifting said double wheeled bin into the air and transporting it to another location.

2. The attachment bracket of claim 1, further comprising a pair of skid members respectively and rotational attached on said distal end portions of said movable members.

3. The attachment bracket of claim 1, wherein said secondary hook members are biased with respect to said main hook members by coil spring members.

4. The attachment bracket of claim 3, further comprising a pair of piston members connected between respective pairs of said main and secondary hook members, and are adapted to function as shock absorbers in conjunction with said coil spring members.

5. The attachment bracket of claim 1, further comprising a plow plate member securely attached to said bracket frame members on portions thereof adjacent and below said main and secondary hook members; and wherein said plow plate member includes plow hooks adapted to connect with a plow member attach to said heavy machinery.

6. The attachment bracket of claim 1, wherein said main and secondary hook members can be slidably moved and adjustably secured to said wide plate member to thereby be adapted to accommodate and attach to variously sized mechanical members of said heavy machinery.

7. The attachment bracket of claim 1, further comprising ratchet members respectively connected between each main and secondary hook member, to thereby hold said secondary hook members in respective desired position during operation.

8. A combination of a double wheeled bin and an attachment bracket for use with heavy machinery, wherein said attachment bracket is adapted to releasably attach said double wheeled bin to said heavy machinery, said double wheeled bin comprising a frame including an attachment portion that is adapted to releasably secure to said attachment bracket, a pair of wheels attached to said frame by respective rotatable wheel forks, and a bin adapted to fit and removably attach to said frame; and said attachment bracket comprising of a plurality of spaced parallel elongated bracket frame members; an elongated wide plate member connected to each said bracket frame member forming a rigid connection therebetween; a pair of spaced main hook members removably and adjustably connected to said wide plate member in between said bracket frame members; a pair of secondary hook members, each rotationally connected to a respective said main hook member and biased such that they will return to an initial position when not being forced to rotate; a pair of arms extending in a perpendicular direction from base portions of two of said bracket frame members, and in a direction opposite from the direction said main and secondary hooks extend, each arm having an attachment notch on a distal end thereof; a pair of spaced parallel elongated movable members; at least one connector member extending between and connecting said movable members, and having a length that is greater than the elongated length of said wide plate member; an attachment connector member attached between top portions of said movable member, has a length that is greater than the length of said at least one connector member and is adapted to removably and securely attach to said double wheeled bin; two attachment pins respectively located on distal end portions of said movable members and are adapted to respectively rotationally and removably engage with said pair of arms; and two limiting rods respectively located on middle sections of said movable members and are adapted to respectively engage middle portions of said pair of arms thereby limiting rotational movement of said movable members with respect to said pair of arms, such that when said main and secondary hook members are engaged and lifted by heavy machinery said attachment bracket is secured thereon and capable of lifting said double wheeled bin into the air and transporting it to another location.

9. The combination of claim 8, wherein said attachment bracket further comprising a pair of skid members respectively and rotational attached on said distal end portions of said movable members.

10. The combination of claim 8, wherein said secondary hook members are biased with respect to said main hook members by coil spring members; and further comprising a pair of piston members connected between respective pairs of said main and secondary hook members, and are adapted to function as shock absorbers in conjunction with said coil spring members.

11. The combination of claim 8, wherein said attachment bracket further comprising a plow plate member securely attached to said bracket frame members on portions thereof adjacent and below said main and secondary hook members; and wherein said plow plate member includes plow hooks adapted to connect with a plow member attach to said heavy machinery.

12. The combination of claim 8, wherein said main and secondary hook members can be slidably moved and adjustably secured to said wide plate member to thereby be adapted to accommodate and attach to variously sized mechanical members of said heavy machinery.

13. The combination of claim 8, wherein said attachment bracket further comprising ratchet members respectively connected between each main and secondary hook member, to thereby hold said secondary hook members in respective desired position during operation.

14. The combination of claim 8, wherein said attachment bracket further comprises a pair of small hook members respectively located on back sides of said main hook members and mechanically connected to respective secondary hook members; a pair of channel members respectively located on back sides of said main hook members; as the frame moves in relation to the main hooks, at least one cable is pulled by the action of said frame moving and said at least one cable threaded through each respective said channel member to a set of pulleys; a pair of wheel locking mechanisms each adapted to mechanically attach to a respective wheel of said pair of wheels, and wherein each of said wheel locking mechanisms include wheel locking notches, and a pair of blockers, wherein said at least one cable engages said set of pulleys and attaches to respective said wheel locking mechanisms to thereby move respective said blockers into or out from notches of said wheel locking notches, to thereby either block said pair of wheels from rotating, or releasing said pair of wheels to rotate freely, such that when said attachment bracket is engaged and lifted by heavy machinery said pair of wheels of said double wheeled bin are locked in place and said double wheeled bin is safely lifted into the air to be transported to another location.

15. A combination of an excavator machine, a double wheeled bin, and an attachment bracket, wherein said attachment bracket is adapted to releasably attach said double wheeled bin to said excavator machine, said excavator machine including an excavator arm; and a bucket member attached to the end of said excavator arm, wherein said bucket member includes an elongated cylindrical bucket attachment pin; said double wheeled bin comprising a frame including an attachment portion that is adapted to releasably secure to said attachment bracket, a pair of wheels attached to said frame by respective rotatable wheel forks, and a bin adapted to fit and removably attach to said frame; and said attachment bracket comprising of a plurality of spaced parallel elongated bracket frame members; an elongated wide plate member connected to each said bracket frame member forming a rigid connection therebetween; a pair of spaced main hook members adapted to receive said elongated cylindrical bucket attachment pin therein and removably and adjustably connected to said wide plate member in between said bracket frame members; a pair of secondary hook members adapted to receive said elongated cylindrical bucket attachment pin therein and each rotationally connected to a respective said main hook member and biased such that they will return to an initial position when not being forced to rotate; a pair of arms extending in a perpendicular direction from base portions of two of said bracket frame members, and in a direction opposite from the direction said main and secondary hooks extend, each arm having an attachment notch on a distal end thereof; a pair of spaced parallel elongated movable members; at least one connector member extending between and connecting said movable members, and having a length that is greater than the elongated length of said wide plate member; an attachment connector member attached between top portions of said movable member, has a length that is greater than the length of said at least one connector member and is adapted to removably and securely attach to said double wheeled bin; two attachment pins respectively located on distal end portions of said movable members and are adapted to respectively rotationally and removably engage with said pair of arms; and two limiting rods respectively located on middle sections of said movable members and are adapted to respectively engage middle portions of said pair of arms thereby limiting rotational movement of said movable members with respect to said pair of arms, such that when said main and secondary hook members are engaged by said elongated cylindrical bucket attachment pin and lifted by said excavator said attachment bracket is secured thereon and capable of lifting said double wheeled bin into the air and transporting it to another location.

16. The combination of claim 15, wherein said attachment bracket further comprising a pair of skid members respectively and rotational attached on said distal end portions of said movable members; and wherein said attachment bracket further comprising ratchet members respectively connected between each main and secondary hook member, to thereby hold said secondary hook members in respective desired position during operation.

17. The combination of claim 15, wherein said secondary hook members are biased with respect to said main hook members by coil spring members; and further comprising a pair of piston members connected between respective pairs of said main and secondary hook members, and are adapted to function as shock absorbers in conjunction with said coil spring members.

18. The combination of claim 15, wherein said attachment bracket further comprising a plow plate member securely attached to said bracket frame members on portions thereof adjacent and below said main and secondary hook members; and wherein said plow plate member includes plow hooks adapted to connect with a plow member that is attachable to said excavator.

19. The combination of claim 15, wherein said main and secondary hook members can be slidably moved and adjustably secured to said wide plate member to thereby be adapted to accommodate and attach to variously sized bucket members of said excavator.

20. The combination of claim 15, wherein said attachment bracket further comprises a pair of small hook members respectively located on back sides of said main hook members and mechanically connected to respective secondary hook members; a pair of channel members respectively located on back sides of said main hook members; a pair of cables respectively connected to each small hook member and threaded through each respective said channel member to be attached to said double wheeled bin, such that when said secondary hooks are rotated said small hooks move linearly within said respective channel members thereby moving said cables; and wherein said double wheeled bin further comprises a set of pulleys; a pair of wheel locking mechanisms each adapted to mechanically attach to a respective wheel of said pair of wheels, and wherein each of said wheel locking mechanisms include wheel locking notches, and a pair of blockers, wherein said pair of cables respectively engages said set of pulleys and attaches to respective said wheel locking mechanisms to thereby move respective said blockers into or out from notches of said wheel locking notches, to thereby either block said pair of wheels from rotating, or releasing said pair of wheels to rotate freely, such that when said attachment bracket is engaged and lifted by said excavator said pair of wheels of said double wheeled bin are locked in place and said double wheeled bin is safely lifted into the air to be transported to another location.
